(19) United States
(12) Patent Application Publication
(10) Pub. No.: US 2012/0057341 A1
(43) Pub. Date: Mar. 8, 2012

(54) Lantern, and Method for Retrofitting a Lantern

(75) Inventors: Steffen Block, Lauterach (AT); Christoph Neureuther, Hong Kong (HK); Ales Markytan, Regensburg (DE)

(73) Assignee: OSRAM Opto Semiconductors GmbH, Regensburg (DE)

(21) Appl. No.: 13/127,218

(22) PCT Filed: Oct. 19, 2009
(86) PCT No.: PCT/DE2009/001447

§ 371 Date: Nov. 23, 2011

(30) Foreign Application Priority Data
Oct. 30, 2008 (DE) 10 2008 054 050.1

(51) Int. Cl. F21V 33/00; F21S 10/02; B23P 23/00; F21S 6/00

(52) U.S. Cl. 362/234; 362/249.02; 362/249.06; 315/360; 29/401.1

(57) ABSTRACT

A lantern is disclosed that includes a lamp post (2) and at least two light emitting diodes (4) that are set up to emit, in operation, electromagnetic radiations (12) with electromagnetic spectra (17, 19) differing from one another, the light emitting diodes (4) being fastened in or on the lamp post (2).

A lantern is specified. Also specified is a method for converting an existing lantern. The lantern can be used in this case for general light. In particular, the lantern can be a street lamp that is provided for lighting traffic routes or public spaces.

Publication DE 203 17 444 U1 describes a lantern.

One object to be achieved consists, inter alia, in specifying a lantern that has an improved emission characteristic. A further object to be achieved consists, inter alia, in specifying a lantern that is particularly well protected against external contamination. A further object to be achieved consists, inter alia, in specifying a method for converting an existing lantern by means of which it is possible to produce a lantern having an improved emission characteristic and/or improved protection against contamination.

In accordance with at least one embodiment of a lantern described here, the lantern comprises a lamp post. The lantern lamp post can, for example, be installed at the end of a street so that it runs at least partially perpendicularly, or substantially perpendicularly into the subsoil on which it is fastened. The lamp post serves as a support for the light source or light sources of the lantern.

In accordance with at least one embodiment of the lantern, the lantern comprises at least two light emitting diodes that serve as light sources of the lantern. The light emitting diodes are preferably light emitting diodes that emit electromagnetic radiation in the wavelength region of visible light. The lantern preferably comprises a multiplicity of such light emitting diodes, which can together form the sole light source of the lantern. Alternatively, it is possible for the light emitting diodes to be additional light sources of the lantern, and for the lantern to have conventional luminous means as a light source in addition to the light emitting diodes.

In accordance with at least one embodiment of a lantern described here, the lantern comprises at least two light emitting diodes that are set up to emit, in operation, electromagnetic radiations with electromagnetic spectra differing from one another. That is to say, the lantern comprises at least two light emitting diodes that are not light emitting diodes of the same design. The light emitting diodes differ from one another at least in the electromagnetic spectra of the electromagnetic radiation emitted by them. For example, at least two light emitting diodes of the lantern are set up to emit, in operation, light of colors differing from one another.

Furthermore, it is certainly possible for at least two light emitting diodes of the lantern to have identical light emitting diode chips and yet to have a different luminescence conversion material. It is possible in this way to achieve a difference in the electromagnetic spectrum of the electromagnetic radiation from the light emitting diodes in operation.

A different electromagnetic spectrum of two light emitting diodes is not to be understood here as a small deviation in the spectrum such as can occur with light emitting diodes of the same design, for example, but rather the spectra of the light emitting diodes differ from one another more strongly. The light emitting diodes emit either light of different colors in such a way that the difference can be perceived by a human observer, or the light emitting diodes emit white light of different color temperature in such a way that the difference in the color temperature can be perceived by a human observer.

In accordance with at least one embodiment of a lantern described here, the lantern comprises at least two light emitting diodes that are fastened in or on the lamp post. The light emitting diodes can in this case be light emitting diodes that emit, in operation, electromagnetic radiations with electromagnetic spectra differing from one another.

If light emitting diodes are fastened in the lamp post, the lamp post does not have a plain or smooth outer surface, but it comprises depressions or recesses in which light emitting diodes are arranged.

If light emitting diodes are fastened on the lamp post, the light emitting diodes can be mounted directly on the lamp post, or the light emitting diodes are fastened on one or more circuit boards that are fastened directly on the lamp post.

Overall, the light emitting diodes are not inserted in a further component of the lantern such as a lamp head, for example, but the light emitting diodes are installed in or on the lamp post and electrical contact is made with them there. The light emitting diodes can in this case be fastened in or on the lamp post indirectly or directly. If the light emitting diodes are fastened indirectly in or on the lamp post, at least one circuit board on which the light emitting diodes are mounted is located between the light emitting diodes and the lamp post. The mounting surface, averted from the light emitting diodes, of the circuit board is then fastened in or on the lamp post. The light emitting diodes are preferably fastened in or on the lamp post in such a way that at least a portion of the electromagnetic radiation generated in operation by the light emitting diodes is directed away from the lamp post.

In accordance with at least one embodiment of a lantern described here, the lantern comprises a lamp post and at least two light emitting diodes that are set up to emit, in operation, electromagnetic radiations with electromagnetic spectra differing from one another. The light emitting diodes are fastened in this case in or on the lamp post.

One lantern described here makes use in this case, inter alia, of the knowledge that when light emitting diodes are fastened in or on the lamp post, heat generated from the operation of the light emitting diodes can be particularly well dissipated via the lamp post. For example, the light emitting diodes can therefore be fastened on the lamp post by means of a relatively cost effective FR4 circuit board.

By way of example, a circuit board is a circuit board with a basic body that is based on a plastics material such as FR4, for example. Vias that conduct heat from a top side of the basic body to the underside are introduced into the basic body. Furthermore, a thermally conducting material (so-called thermal interface material) can be used to connect the circuit board thermally to the lamp post. The thermally conducting material can be electrically insulating. By way of example, the thermally conducting material is a double sided adhesive strip that is arranged between the lamp post and circuit board.

The heat generated in operation by the light emitting diodes is dissipated via the lamp post, which is preferably formed with a metal. This results in a better efficiency, a greater brightness, a better aging behavior and a lesser color shift of the light emitting diodes that are fastened in or on the lamp post. It has, moreover, emerged that fastening luminous means in or on the lamp post has the effect that a lesser contamination of the luminous means can take place. Thus, for example, with a lantern designed in this way it is possible to dispense with a lamp head, which often serves as a resting place for birds. A contamination of the light sources of the lantern, for example by bird droppings, is thereby reduced.

Furthermore, one lantern described here is distinguished in that use is found of at least two light emitting diodes that are set up to emit, in operation, electromagnetic radiations with electromagnetic spectra differing from one another. This brings the advantage that by separating the driving of the different light emitting diodes it is possible to adapt the spectrum of the mixed light emitted by the lantern to the light generated by the lantern, in accordance with requirements. Thus, the spectrum of the electromagnetic radiation of the mixed light emitted by the lantern can, for example, be optimized to the effect that fewer insects fly towards the light emitting diodes. Consequently, the light emitting diodes are contaminated to a lesser extent by insects, and this in turn has a favorable influence on the efficiency, the brightness and the aging of the light emitting diodes, and thus of the entire lantern.

In accordance with at least one embodiment of a lantern described here, the distance between two light emitting diodes that are fastened in or on the lamp post of the lantern in a direction of main extent of the lamp post is at least 1/40th of the length of the lamp post. The direction of main extent of the lamp post runs parallel to the lamp post, for example perpendicular, or substantially perpendicular to the subsoil on which the lamp post is fastened. The two light emitting diodes are, for example, the light emitting diode that, with reference to the subsoil, is fitted highest on the lamp post or in the lamp post, as well as the light emitting diode fastened lowest in or on the lamp post. The distance between these two light emitting diodes along the direction of main extent is then at least a 1/40th of the entire length of the lamp post, the length of the lamp post being determined from the subsoil of the lamp post up to the opposing top of said lamp post. A multiplicity of further light emitting diodes are preferably arranged along the lamp post between the two light emitting diodes.

Overall, this specifies a lantern which is distinguished by a particularly large luminous surface. In other words, a relatively large section of the lamp post serves as support for the light emitting diodes, the result of this being overall a particularly large luminous surface for the lantern. That is to say, light is coupled out from the lantern over a relatively large surface, and this leads to a reduction in the luminance of the light emitted by the lantern in comparison with a lantern where the light source is not distributed over the lamp post, but is, for example, arranged centrally in a lamp head. The result of this is less glare from the generated light, and it is possible to use the lantern to provide lighting in a more homogeneous and energy saving way. Moreover, the enlarged luminous surface and the luminance reduced thereby render the lantern less attractive to insects.

In accordance with at least one embodiment of a lantern described here, the distance between two light emitting diodes which are fastened in or on the lamp post in a direction of main extent of the lamp post, is at least 1/20th, preferably at least 1/10th of the length of the lamp post. The luminous surface of the lantern is further enlarged in this way.

In accordance with at least one embodiment of a lantern described here, the lantern comprises at least one row of light emitting diodes that extends along the direction of main extent of the lamp post, each row comprising at least two light emitting diodes. The lantern preferably comprises two or more such rows. The light emitting diodes of a row can, for example, be connected in series, and can to this end be arranged on a common circuit board. The lamp post of a lantern can be fitted with a multiplicity of light emitting diodes in a particularly simple way by means of the formation of rows of light emitting diodes.

In accordance with at least one embodiment of a lantern described here, at least one light emitting diode for the lantern is arranged on a top of the lamp post. This light emitting diode can, for example, serve the purpose of illuminating the lamp post itself, and in this way makes it easier for the users of motor vehicles for example, to detect the course of the road.

The light emitting diode arranged on the top of the lamp post can in this case emit light of a different color from the light of the remaining light emitting diodes of the lantern. This further increases the detectability of the lantern. Furthermore, the light emitting diode can serve as a design element and decorative element.

In accordance with at least one embodiment of the lantern, the lamp post has a bend. By way of example, the lamp post can be bent in the manner of a swan neck. The top of the lamp post is then located below the highest point of the lamp post. In this embodiment, as well, it is possible to arrange on the top of the lamp post a light emitting diode that increases the visibility of the lamp post. Owing to the bend of the lamp post, it is then possible for the light emitting diode also to illuminate the lamp post so that the lamp post is particularly well visible to pedestrians or cyclists. The light emitting diode therefore also serves to illuminate the lamp post. Furthermore, the light emitting diode can serve as a design element and decorative element.

In accordance with at least one embodiment of a lantern described here, the lantern has no lamp head. That is to say, in addition to the lamp post the lantern comprises no further component that is arranged, for example, on the top of the lamp post and in which light sources of the lantern are concentrated. The elimination of a lamp head is particularly possible by virtue of the fact that at least two light emitting diodes are fastened in or on the lamp post. Owing to the elimination of a lamp head, there is, for example, no place for birds to sit on the lantern, and this reduces the contamination of the lantern. Moreover, a lantern without a lamp head offers less resistance to the wind. This can prove to be advantageous, particularly in areas with a high wind speed such as, for example, coastal areas or in mountains. The elimination of a lamp head then improves the service life of the lantern.

In accordance with one embodiment of a lantern described here, the lamp post tapers in the direction of its top. That is to say, the lamp post tapers in the direction of its top, and so the cross sectional surface of the lamp post reduces in the direction of its top. This further diminishes the possibility of, for example, birds being able to settle on the lantern.

In accordance with at least one embodiment of a lantern described here, the lamp post is designed at least partially as a reflector for the electromagnetic radiation generated in operation by the light emitting diodes. That is to say, electromagnetic radiation generated in operation by the light emitting diodes can impinge on the lamp post and is then reflected with a reflectivity of at least 50%, preferably at least 80%, with particular preference of at least 90%. To this end, the lamp post can be at least partially coated with a particularly effectively reflecting material, such as aluminum. Overall, this measure further increases the efficiency of the generation of light by the lantern. Furthermore, this measure ensures a homogeneous light distribution and results in little glare from the generated light.

In accordance with at least one embodiment of a lantern described here, a multiplicity of light emitting diodes are arranged as a ring, the ring enclosing the lamp post. That is to say, preferably at least four light emitting diodes are arranged annularly around the lamp post. This luminous ring can, for example, be fitted at a height of at least 1 m and at most 2 m above the subsoil at the lamp post. In this case, the ring composed of light emitting diodes can increase the visibility of the lantern, and thus make the course of the road and the road boundary more visible to the car driver and other road users. The light emitting diodes that are arranged as a ring can in this case have a different color of the light they emit in comparison with the light emitting diodes that are fastened as light sources of the lantern in or on the lamp post. It is, moreover, possible that the light emitting diodes arranged as a ring are part of the actual light source of the lantern. Furthermore, it is possible for colored light emitting diodes that do not form the actual light source of the lantern to be arranged in further patterns on or in the lamp post. These light emitting diodes can, for example, be arranged in such a way that they form simple logos, badges, information signs or the like.

In accordance with at least one embodiment of a lantern described here, the lantern comprises one sensor that is fastened on or in the lamp post, the sensor serving to determine at least one of the following measured variables: temperature, air humidity, ambient brightness, visibility conditions. The sensor can therefore be used to determine measured variables as a function of which the light sources of the lantern can be driven. It is possible here for the lantern to comprise a plurality of sensors. Thus, the lantern can comprise a temperature sensor, a sensor for the air humidity and a further sensor for the ambient brightness.

In order to determine the visibility conditions, that is to say to determine whether rain, fog, snow, smog or similar is present, a light signal can be sent from one lantern to the adjacent lantern. A sensor then determines the intensity of the light signal. It is possible therefrom to draw conclusions about the scattering of the light signal and thus of the visibility conditions. A light emitting diode or a laser diode in or on the lamp post can be used to generate the light signal in the visible or nonvisible region of the electromagnetic spectrum.

In accordance with at least one embodiment of a lantern described here, a lantern has a device that is set up to control and/or to regulate the electromagnetic spectrum and the intensity of the mixed light emitted by the light emitting diodes. The device is, for example, a digital circuit with a microcontroller, or an analog circuit. The device can be used to drive individual light emitting diodes of the lantern, or individual rows of light emitting diodes of the lantern. For example, the device can be used to switch the light emitting diodes on and off, the current with which the light emitting diodes are operated can be varied continuously or in stepwise fashion, and/or the light emitting diodes can be dimmed. This can be carried out by varying the current intensity and/or by pulse width modulation. Since the electromagnetic spectra of at least two of the light emitting diodes differ from one another, the device can drive the light emitting diodes to vary the electromagnetic spectrum and the intensity of the mixed light emitted by the light emitting diodes.

Here, the device can control the spectrum and the intensity in accordance with a program run. For example, the light emitting diodes, and thus the spectrum and the intensity of the mixed light emitted by the light emitting diodes can be controlled as a function of a user input, or as a function of the time of day and/or season. Moreover, it is possible for the device to be suitable, in addition or as an alternative, for regulating the electromagnetic spectrum and the intensity. By way of example, to this end the lantern comprises a sensor that determines the temperature of the light emitting diodes and/or the ambient brightness. As a function of these values, the light emitting diodes, and thus the electromagnetic spectrum and the intensity of the emitted mixed light, can be regulated so as to achieve a specific desired value for measured variables such as temperature, ambient brightness or visibility conditions.

In other words, owing to the device, the lantern does not have a fixed, invariable spectrum of electromagnetic radiation, but the electromagnetic spectrum and the intensity of the emitted light can be varied by means of the device. It is thereby possible for the lantern to react to external influences such as ambient brightness, ambient temperature, temperature of the light emitting diodes, air humidity, for example rain, time of day, season, visibility conditions, or other events. The light quality of the lantern can thereby be increased. Furthermore, the light generated in operation by the lantern can be adapted to the requirements of use, such as the time of day, the weather and the like.

In accordance with at least one embodiment of a lantern described here, the lantern comprises a device that is set up to control and/or to regulate the electromagnetic spectrum and intensity of the mixed light emitted by the light emitting diodes as a function of at least one of the following measured variables: air humidity, temperature, ambient brightness, time of day, season and visibility conditions. Sensors that may be required to determine these measured variables can in this case be located in or on the lamp post of the lantern, or arranged centrally outside the lantern, it thereby being possible to use the same measured variables for a multiplicity of lanterns. Again, the device for controlling the light emitting diodes and thus the electromagnetic spectrum and the intensity of the emitted mixed light can be located centrally outside the lantern for a plurality of lanterns.

A method for converting a lantern is also specified. The method preferably comprises the following steps: firstly, the lamp head is removed from an existing, conventional lantern. In a further method step, which can also be performed before the removal of the lamp head, at least two light emitting diodes are fastened to the lamp post, that are set up to emit, in operation, electromagnetic radiations with electromagnetic spectra differing from one another.

It is possible, in particular, to use the method to produce lanterns such as those described in conjunction with the preceding embodiments. That is to say, all the features that are disclosed in conjunction with a lantern described here are also disclosed for the method.

The lanterns described here and the method described here for converting a lantern are described in more detail below with the aid of exemplary embodiments and the associated figures, of which:

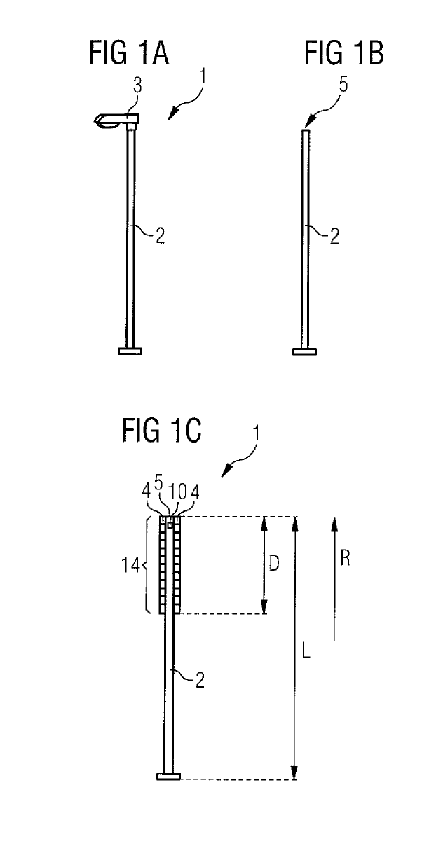

FIGS. 1A to 1C are schematics of an exemplary embodiment of a method described here for converting a lantern;

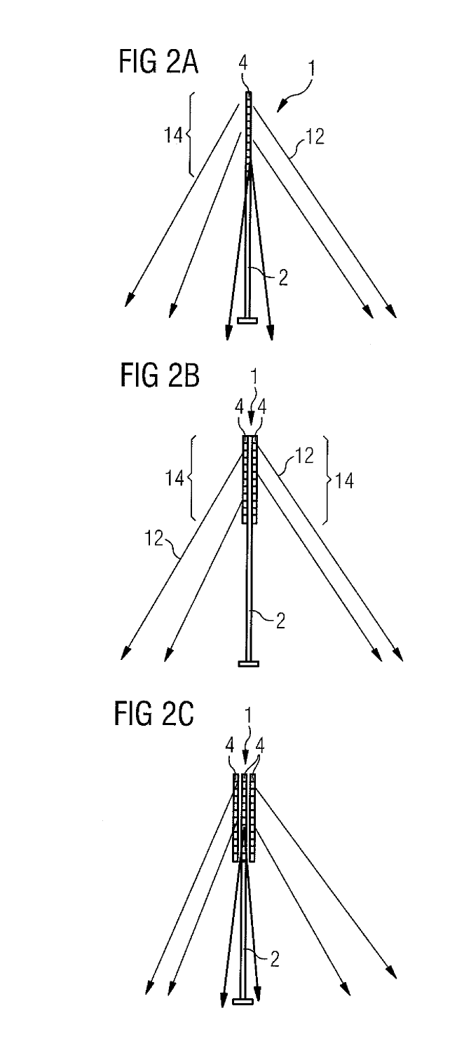

FIGS. 2 to 6 are schematics of exemplary embodiments of lanterns described here;

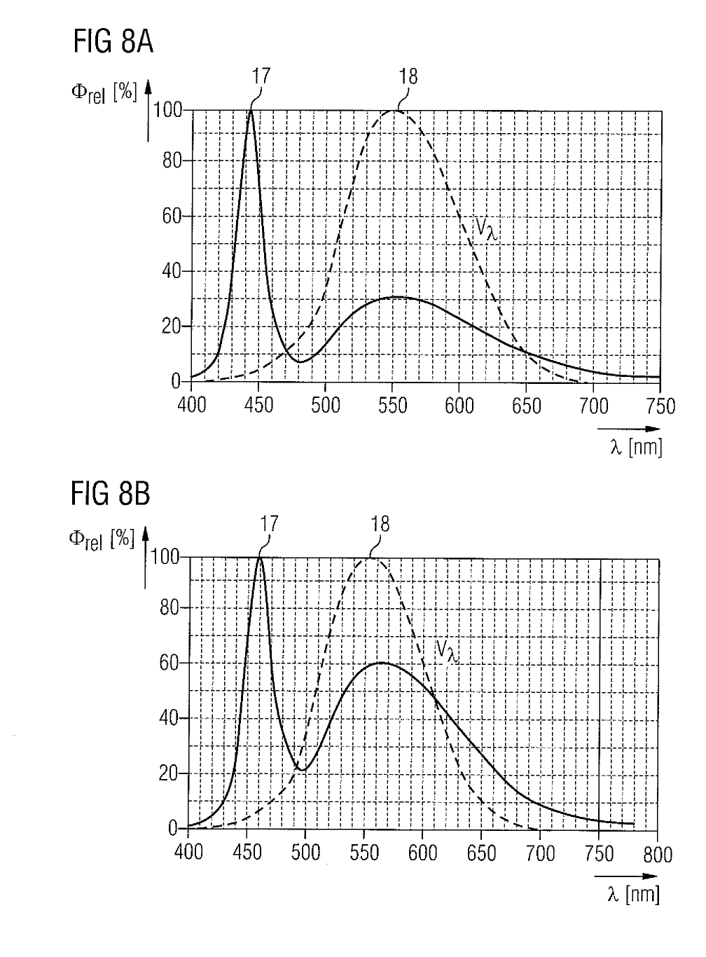

FIG. 7 is a schematic plan view of the lighting of a street with the aid of lanterns described here;

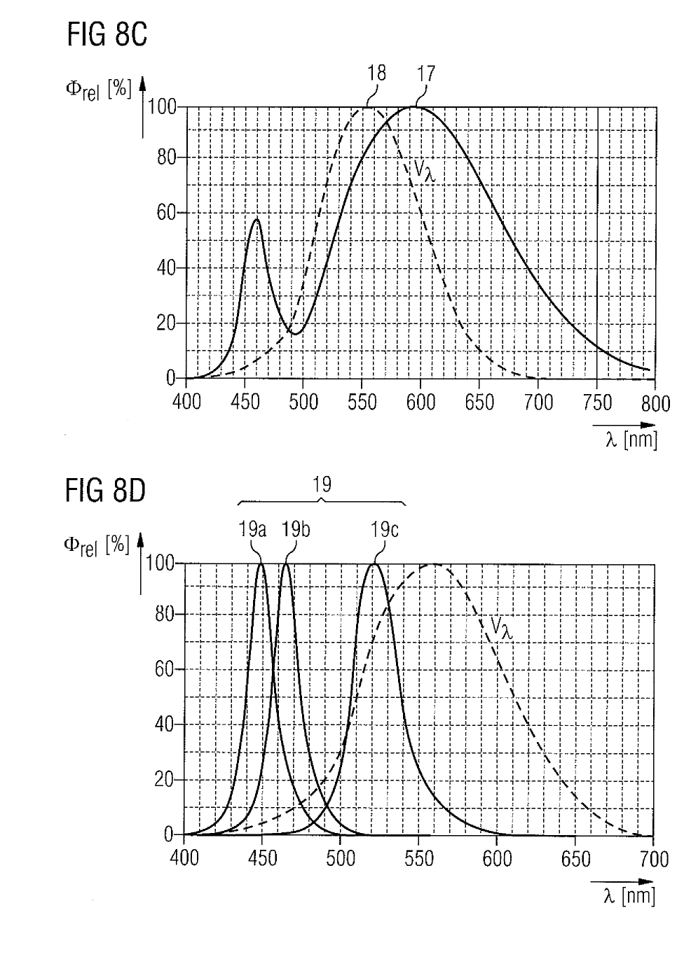

FIGS. 8A to 8D employ schematic plots to show electromagnetic spectra of light emitting diodes such as are used in lanterns described here;

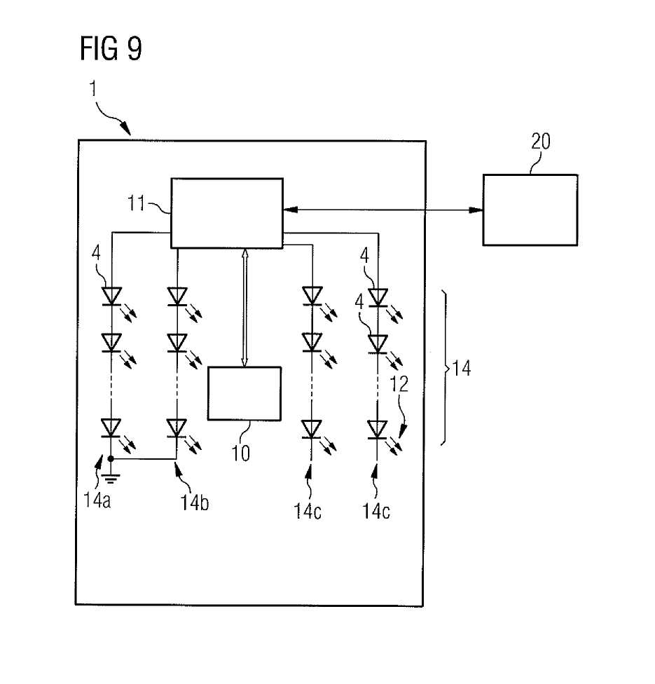

FIG. 9 is a schematic circuit diagram for driving light emitting diodes in lanterns described here;

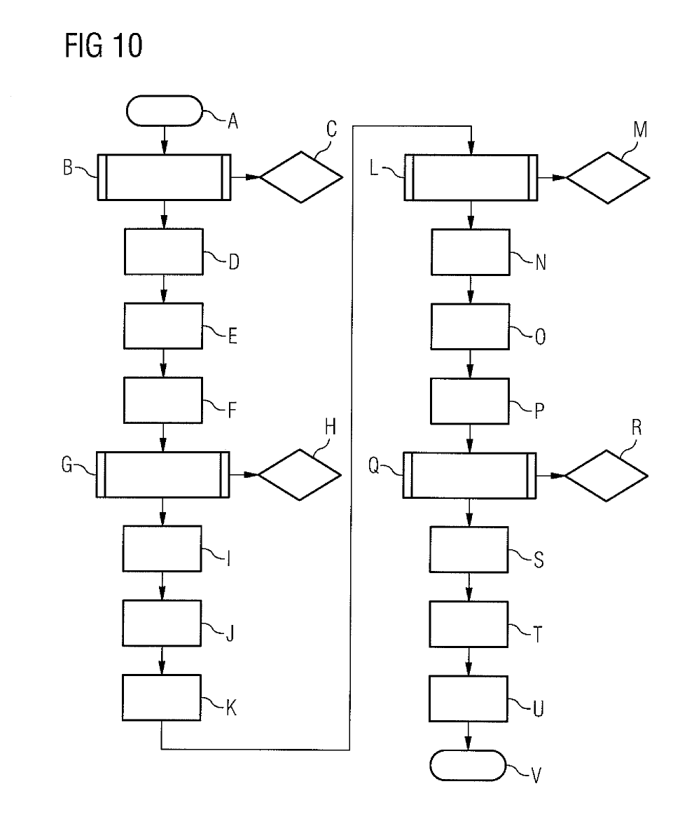

FIG. 10 is a flow chart for controlling a lantern described here; and

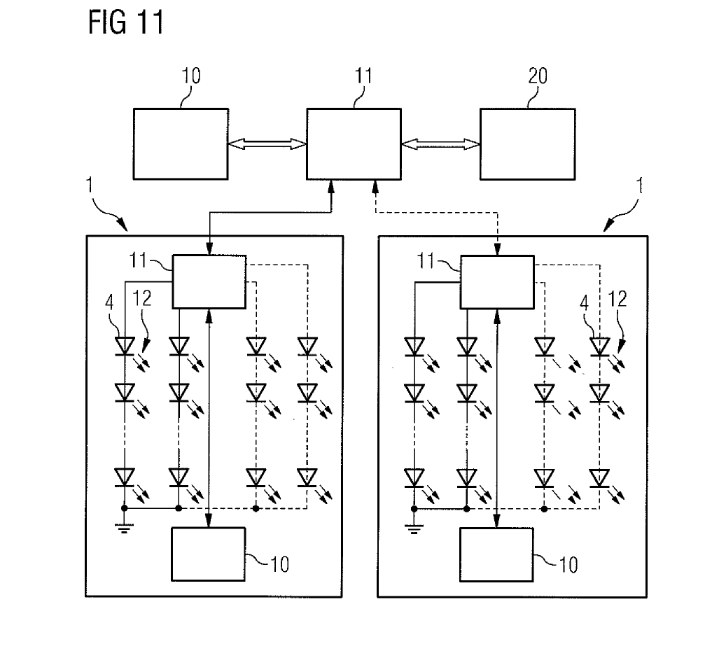

FIG. 11 is a schematic circuit diagram for driving a plurality of lanterns described here.

Identical, similar or identically active elements are provided with the same reference symbols in the figures. The figures and the dimensions of the elements illustrated in the figures in relation to one another are not to be regarded as being to scale. Rather, individual elements can be illustrated over size for the purpose of ease of illustration and/or of better understanding.

An exemplary embodiment of a method described here for converting a lantern, in particular a street lamp is described in more detail in conjunction with FIGS. 1A to 1C. FIG. 1A is a schematic of a conventional lantern 1 with a lamp post 2 and a lamp head 3 on the top 5 of the lamp post 2.

The lamp head 3 is removed from the lamp post 2 in the method described in conjunction with FIG. 1B, and so the top 5 of the lamp post is exposed. The top 5 is not necessarily tapered in this case, but merely constitutes the upper end of the lamp post 2. The top can subsequently be sealed for protection against rain, for example.

It is illustrated schematically in conjunction with FIG. 1C that at least one row 14 of light emitting diodes 4 is fastened on the lamp post 2, specifically along the lamp post. For example, the light emitting diodes 4 are mounted in this case in a row 14 on a common circuit board. The common circuit board can, for example, be a flexible circuit board that has a basic body that consists of FR4 and has thermal vies. Furthermore, it is possible to fit on the lamp post 2 at least one sensor 10 with the aid of which, for example, the ambient brightness in the region of the lantern 1 can be detected. The maximum distance D between two light emitting diodes 4 in the direction of main extent R of the lamp post 2 in this case preferably amounts to at least 1/40th of the total length L of the lamp post 2. The total length L of the lamp post 2 is measured here from the subsoil, on which the lamp post 2 is mounted, up to the top 5 of the lamp post 2. The total length L of the lamp post 2 is, for example, between 6 m and 10 m.

It is preferred to fasten a multiplicity of light emitting diodes 4 on the lamp post 2. Preferably, at least two of the light emitting diodes 4 differ from one another with regard to the electromagnetic spectrum of the light emitted by them in operation.

Various possibilities for fitting a row 14 of light emitting diodes 4 on a lamp post 2 are described in conjunction with FIGS. 2A to 2C.

An exemplary embodiment in which a multiplicity of light emitting diodes 4 are fastened along a single row 14 on the lamp post 2 is described in conjunction with FIG. 2A. In operation, the light emitting diodes 4 emit electromagnetic radiation 12 that mixes to form the mixed radiation of the lantern 1. The direction of the emitted radiation can be set depending on the requirements of use for the lantern 1, either by the mounting or by optical elements such as lenses and/or reflectors of the light emitting diodes 4.

Shown here in conjunction with FIG. 2B is an exemplary embodiment of a lantern 1 described here, in the case of which two rows 14 of light emitting diodes 4 are fastened on the lamp post 2. In this exemplary embodiment, the rows 14 can run obliquely so that the main direction of radiation of the light emitting diodes 4 be directed towards the subsoil in which the lantern 1 is fastened. However, it is also possible for optical elements that are arranged downstream of the light emitting diodes 4 to determine the direction of radiation of the electromagnetic radiation 12 emitted by the light emitting diodes 4.

Otherwise than in the exemplary embodiment of FIG. 2B, the exemplary embodiment of FIG. 2C illustrates a lantern 1 in the case of which at least three rows 14 of light emitting diodes 4 are fastened on the lamp post 2. In this exemplary embodiment, the lantern illuminates to both sides of the lamp post in order to attain a homogeneous illumination and maximum spacings of neighboring lamp posts. The middle row 14 serves the purpose of more effectively illuminating the near zone of the lamp post 2.

Owing to the fact that the light emitting diodes 4 are distributed along a relatively large part of the lamp post 2 in the exemplary embodiment of FIGS. 2A to 2C, there is a relatively large luminous surface overall for the lantern 1. This results in a particularly low luminance, and thus in a small effect of glare from the lantern 1.

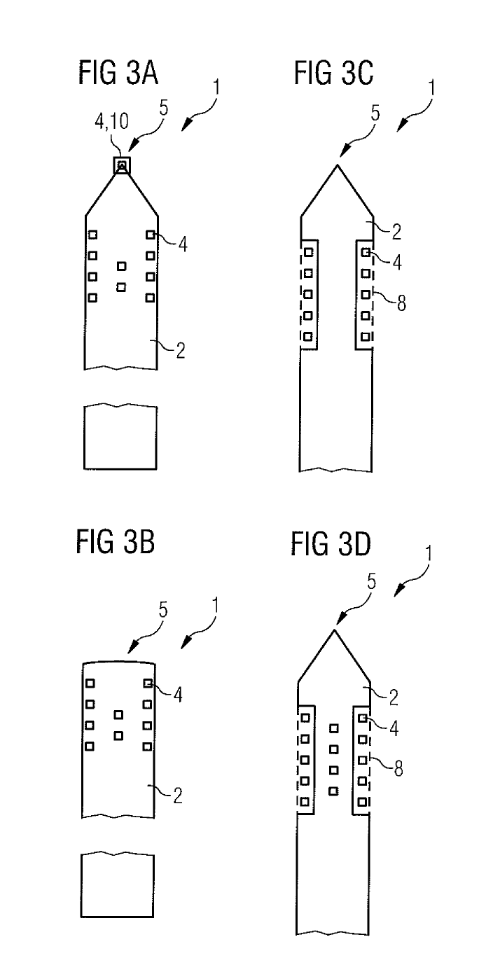

Exemplary embodiments of lanterns 1 described here in the case of which the light emitting diodes 4 are fastened in the lamp post 2 are explained in more detail in conjunction with FIGS. 3A to 3G. To this end, the lamp post 2 has recesses in which the light emitting diodes 4 are arranged. In this case, radiation exit surfaces of the light emitting diodes 4 can terminate flush with the outside of the lamp post 2, or be located below or above the outer surface of the lamp post 2.

An exemplary embodiment of a lantern 1 described here in which a multiplicity of light emitting diodes 4 are integrated in recesses in the lamp post 2 is explained in more detail here in conjunction with FIG. 3A. In this case, electrical conductor tracks for the connection of the light emitting diodes 4 run in the interior of the lamp post 2. In the exemplary embodiment of FIG. 3A, the lamp post has a top 5 towards which the lamp post 2 tapers. A further light emitting diode 4 or a sensor 10 can be arranged on the top 5.

Otherwise than in the exemplary embodiment described in conjunction with FIG. 3A, in conjunction with FIG. 3B an exemplary embodiment of a lantern described here is shown in the case of which the lamp post 2 does not taper in the direction of its top 5. The lamp post 2 is terminated by a straight line at its top 5.

An exemplary embodiment in which, otherwise than in the exemplary embodiment described in conjunction with FIG. 3A, all the light emitting diodes 4 are arranged in a single recess in the lamp post, is explained in more detail in conjunction with FIG. 3C. The light emitting diodes 4 are covered here with a cover plate 8. The cover plate 8 can in this case be designed to be transparent or milky. The cover plate 8 terminates flush with the outer surface of the lamp post 2. In the exemplary embodiment of FIG. 3C, the light emitting diodes 4 are arranged oppositely on two sides of the lamp post.

By contrast therewith, an exemplary embodiment in which the light emitting diodes 4 are arranged on at least three sides of the lamp post 2 is explained in more detail in conjunction with FIG. 3D.

In the exemplary embodiment described in conjunction with FIG. 3E, the lamp post 2 is obliquely arranged in the area in which the light emitting diodes 4 are arranged, so that the main direction of emission of the electromagnetic radiation 12, generated in operation by the light emitting diodes, runs obliquely relative to the main direction of extent R of the lamp post 2, owing to the inclination of the light emitting diodes 4. The light emitting diodes 4 can in this case be covered by a cover plate 8 that terminates flush with the outer surface of the lamp post 2.

An exemplary embodiment of a lantern 1 described here, in the case of which the light emitting diodes 4 are arranged in the lamp post 2 in such a way that the main direction of emission of the radiation 12 emitted in operation by the light emitting diodes 4 runs parallel to the main direction of extent R of the lamp post 2, is explained in more detail in conjunction with FIG. 3F. Areas of the lamp post 2 downstream of the light emitting diodes 4 in the main direction of emission are designed as a reflector 7, which reflects the electromagnetic radiation 12 that strikes it. In the region of the reflector 7, the lamp post 2 is, for example, designed in the manner of a cone or conical frustum, the apex of the cone or of the conical frustum being directed away from the top 5 of the lamp post. In order to form a reflector 7, the lamp post 2 can either be formed by an effectively reflecting material, or is coated with an effectively reflecting material such as, for example, aluminum. The reflector 7 and the light emitting diodes 4 can be covered by a cover plate 8 that terminates flush with the outer surface of the lamp post 2, which does not serve as reflector 7. The emission characteristic of the lantern 1 can be set in this case via the design of the reflector 7.

An exemplary embodiment of a lantern 1 described here in which the lamp post 2 has at least two tops 5 is explained in more detail in conjunction with FIG. 3G. Rows 14 of light emitting diodes 4 are fastened on each of these tops. The light emitting diodes 4 can be fastened in this case in or on the lamp post 2.

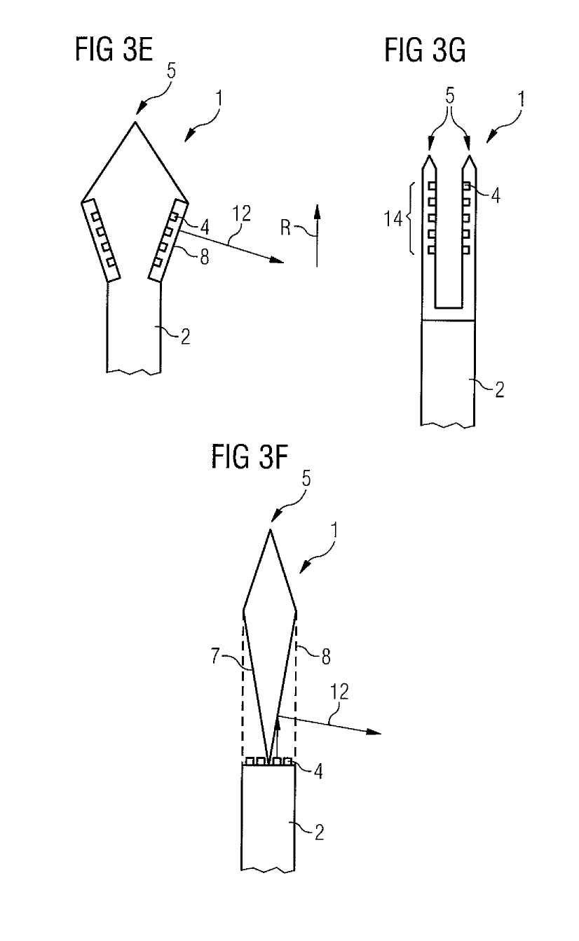

Exemplary embodiments of lanterns 1 described here that have a lamp head 3 are illustrated in conjunction with FIGS. 4A to 4C. In this case, light emitting diodes 4 that are not illustrated can be fastened on or in the lamp post 2 of the lanterns 1, as is explained in more detail, for example, in conjunction with FIGS. 2 and 3. The lamp heads 3 of the lanterns illustrated in conjunction with FIGS. 4A to 4C can in this case comprise light emitting diodes 4 as light sources. The lamp head 3 of the lantern 1 is designed to be bent or angled in these exemplary embodiments. These light emitting diodes 4 can, in particular, themselves serve to illuminate the lamp post 2 so that the latter can be better detected by pedestrians and other road users. Here, a lamp head is understood to be a component of the lantern 1 that is fastened on the top 5 of the lamp post, and overhangs the lamp post 2 at least partially in a lateral direction, that is to say perpendicular to the main direction of extent R of the lamp post 2.

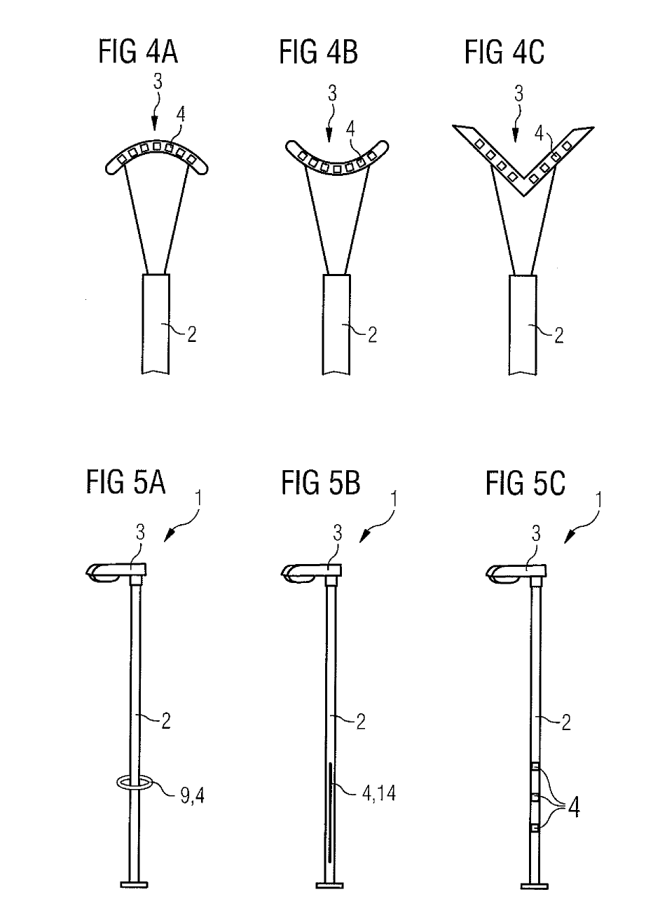

The fact that the light emitting diodes 4 can also be fastened on or in the lamp post of the lantern 1 in the lower third of the lamp post 2, as well, is shown schematically in conjunction with FIGS. 5A to 5C. In this case, the light emitting diodes 4 particularly enable better visibility of the lamp post itself. The lantern can here comprise a main light source that differs from the light emitting diodes 4 and is arranged, for example, in a lamp head 3. However, the lanterns 1 can also comprise light emitting diodes 4 as main light sources, as explained in conjunction with FIGS. 2 and 3, for example.

It is shown in FIG. 5A that the light emitting diodes 4 can be arranged around the lamp post 2 in the manner of a ring. It is shown in conjunction with FIG. 5B that the light emitting diodes 4 can be arranged in a row such that a luminous strip is formed. It is shown in conjunction with FIG. 5C that individual light emitting diodes 4 can be fastened on or in the lamp post 2 in any desired way.

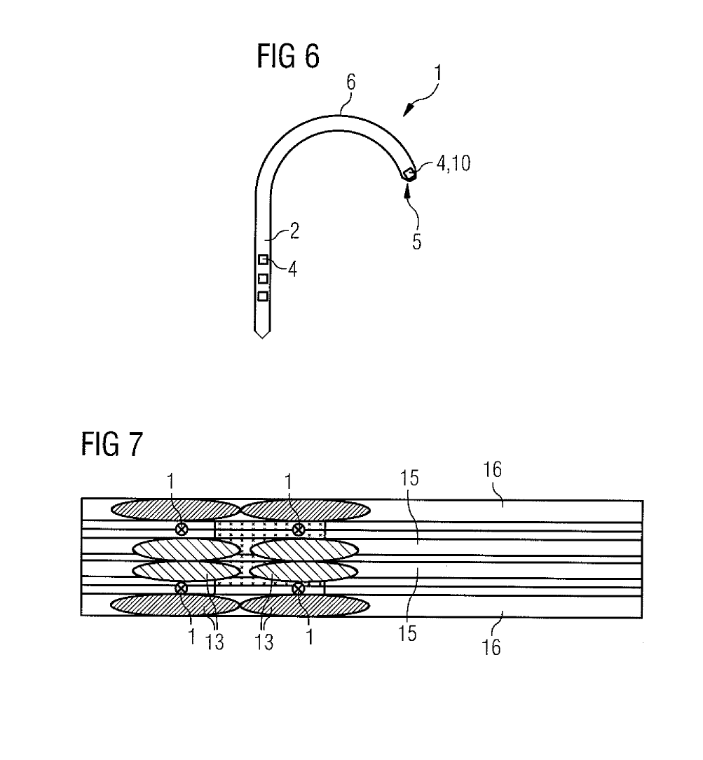

Explained in more detail in conjunction with FIG. 6 is an exemplary embodiment of a lantern 1 described here in the case of which the lamp post 2 has a bend 6 in such a way that the top 5 of the lamp post 2 is located below the highest point of the lamp post 2. A light emitting diode 4 or a sensor 10 can be arranged on the top 5. Light emitting diodes 4 can be arranged on or in the lamp post 2 itself, as is explained in more detail in conjunction with FIGS. 2 and 3, for example.

The lighting of a street 15 and a sidewalk 16 with the aid of lanterns 1 described here is explained in more detail in conjunction with FIG. 7. It is shown schematically in this case that it is possible to produce lit areas 13 not only on the street 15, but also on the sidewalk 16 by means of the lanterns described here. By way of example, to this end the lantern can comprise, in or on the lamp post 2 of the lantern 1, light emitting diodes 4 that light the street 15. Moreover, it is possible for the lantern 1 to have on or in the lamp post, or on the top of the lamp, or in a lamp head of the lantern, light emitting diodes 4 with the aid of which it is also possible to light the sidewalk or other edge areas of the lantern 1 that are averted from the streets. The lighting of edge areas—that is to say, for example, of the sidewalk 16—can in this case be controlled independently and, accordingly, be adapted to the above named measured variables such as ambient brightness and time of day.

The electromagnetic spectra 17 of light emitting diodes such as are used in lanterns 1 described here are plotted schematically in conjunction with FIGS. 8A to 8D with the aid of schematic plots. The spectra are plotted in this case in the form of the relative spectral emission. The plots further show the spectral visual sensitivity curve 18.

Here, FIG. 8A shows the electromagnetic spectrum 17 of an ultrawhite LED with a strong blue component and relatively weak yellow component that is generated, for example, by a luminescence conversion material that is arranged downstream of a blue light emitting diode chip. FIG. 8B shows the electromagnetic spectrum of a neutral white light emitting diode in which the yellow component is increased by comparison with the spectrum of FIG. 8A. FIG. 8C shows the electromagnetic spectrum 17 of a warm white light emitting diode with a weaker blue component and amplified yellow component. FIG. 8D shows the spectra 19 of light emitting diodes 19c emitting in the deep blue 19a, blue 19b and green.

Moreover, light emitting diodes emitting red, green, yellow and other colors can also be used in lanterns described here.

It is preferred to make use of at least two light emitting diodes that differ from one another with regard to their electromagnetic spectrum. For example, use is made in a lantern 1 of ultrawhite light emitting diodes, neutral white light emitting diodes, warm white light emitting diodes, and/or colored light emitting diodes. The mixed light emitted by the lantern can be set with regard to its spectral properties and to its intensity depending on how the light emitting diodes are driven, that is to say as a function of the current intensity with which they are operated, or of their dimming by a pulse width modulation circuit.

Thus, for example, the spectrum can be optimized at twilight as a function of the season—for example in spring and in summer—in order to be particularly friendly to insects. Such an optimization with regard to friendliness to insects can badly affect the color rendering index and/or the efficiency of the lanterns. In order to improve the color rendering and/or the efficiency, it is possible, for example, to change the spectrum of the lantern towards a better color rendering and/or a better efficiency after midnight, when insect flight is reduced. By way of example, it is possible to reduce the blue light component of the emitted light in the interest of an improved insect friendliness. To this end, for example, it is possible to make use in the lantern solely or to an increased extent of warm white light emitting diodes for lighting purposes. Furthermore, it is possible to use light emitting diodes that are, in particular, designed to be friendly to insects, for example which have a particularly low emission of UV radiation.

Furthermore, it is possible to adapt the electromagnetic spectrum and the intensity of the mixed light emitted by a lantern as a function of the weather conditions such as rain, fog, snow or smog. By way of example, the electromagnetic spectrum and/or the intensity of the mixed light emitted by the lantern can be changed in each of these cases.

Furthermore, it is possible to adapt the electromagnetic spectrum of the emitted mixed light as a function of the time of day and/or of the season. By way of example, the spectrum and/or the intensity of the mixed light can be changed as a function of the phases of the moon (full moon, crescent moon, new moon), the seasons or the cloud cover.

It is also possible to adapt the electromagnetic spectrum and the intensity of the mixed light emitted by the light emitting diodes of the lantern to other requirements such as, for example, a particularly good color rendering value. This can be advantageous, for example, in pedestrian zones during twilight and early in the evening. For example, such a light with a high color rendering value is desirable for shopping areas or in the area of restaurants and bars.

The electromagnetic spectrum and the intensity of the mixed light emitted by the lantern can also be adapted as a function of external events such as, for example, an auto accident, a construction site, a diversion or the like. For example, in the case of an accident the lanterns in the surroundings of the accident location can be operated with maximum brightness and a maximum color rendering index. The first-aiders can then better recognize the injuries of the those involved in the accident. By contrast, in the case of construction works it can suffice to select maximum brightness. The lanterns can in this case be controlled centrally, or on the spot by security forces.

An exemplary embodiment of a lantern described here, in the case of which regulation and control can take place as a function of the events and environmental influences just described, is explained in conjunction with FIG. 9 with the aid of a schematic circuit diagram. The lantern comprises a plurality of rows 14 of light emitting diodes 4 that can be connected in series within the rows 14. Alternatively, the light emitting diodes 4 can be driven and/or regulated with the aid of a power electronics that is connected to a microcontroller. The rows 14 are connected to a device that comprises a microcontroller, for example. Optionally, the microcontroller can be connected to a sensor 10 that determines measured variables such as air humidity, ambient temperature, temperature of the light emitting diodes 4 and/or ambient brightness. Furthermore, the device 11 can be suitable, alternatively or in addition, for controlling or for regulating the light emitting diodes 4 as a function of fixed programs such as the time of day, the calendar or external inputs 20 by users.

As an alternative to the circuit diagram shown, it is also possible for the individual light emitting diodes 4 or the individual rows 14 of light emitting diodes 4 to be connected separately to the device 11. In this case, the mixed light of the lantern 1 can be generated with particular accuracy, since each light emitting diode 4 can be addressed individually. Here, the change in the electromagnetic spectrum and in the intensity of the emitted mixed light of the lantern 1 can be brought about by dimming the light emitting diodes 4. For example, different rows 14 of light emitting diodes 4 in this case comprise different groups of light emitting diodes. Here, dimming can be performed by lowering or increasing the current intensity with which the light emitting diodes are operated. Alternatively, it is possible to dim the light emitting diodes 4 by means of a pulse width modulation circuit.

For example, the lantern 1 comprises a row 14a with ultrawhite light emitting diodes as described in conjunction with FIG. 8A. Furthermore, the lantern 1 comprises a row 14b with neutral white light emitting diodes, and two rows 14c with warm white light emitting diodes. If the aim is now, for example, to increase the insect friendliness on the lantern 1 in the time between twilight and midnight, the rows 14a and 14b are operated with no intensity or only low intensity. The rows 14c, in contrast, can be operated with full intensity, with the result that the lantern 10 emits a particularly insect friendly mixed light that has only a small blue component. After midnight, when insect flight is reduced, all the rows 14a, 14b, 14c can be operated with an equal current so that the lantern emits mixed light with a good color rendering value. The rows 14a, 14b, 14c can in this case be operated with reduced intensity, and thus with a higher efficiency.

In conjunction with FIG. 10, a flowchart diagram is explained in more detail, in accordance with which a lantern such as is described in conjunction with FIG. 9, for example, can be operated. The elements of the flowchart are explained briefly below:

A: The program starts.

B: The first program part is started as a function of an internal clock of the device 11; for example, what is involved here is the start of twilight.

C: Optionally, in addition to the internal clock it is possible to make an input by a sensor 10 that, for example, detects the ambient brightness in the area of the lantern 1.

D: The row 14a of light emitting diodes is dimmed to a value that is prescribed, or to a value determined in accordance with the sensor input.

E: The row 14b of light emitting diodes is dimmed to a value that is prescribed, or to a value determined in accordance with the sensor input.

F: The row 14c of light emitting diodes is dimmed to a value that is prescribed, or to a value determined in accordance with the sensor input.

G: A second subprogram is started as a function of the internal clock, for example upon the onset of darkness.

H: Optionally, a sensor 10 can perform an input.

I, J, K: The rows of light emitting diodes 14a, 14b, 14c are, for example, dimmed so as to produce a particularly insect friendly mixed light of the lantern 1.

L: A new subprogram is started as a function of the internal clock—for example, around midnight.

M: Optionally, a sensor 10 can perform an input, when, for example, events such as rain or the like occur.

N, O, P: The rows 14a, 14b and 14c are dimmed for light adapted to situation: for example, a high color rendering value after midnight or particularly low-glare light of reduced intensity in the case of rain.

Q: Start of a subprogram as a function of the time of day, for example at sun up.

R: Optional input of a measured variable by a sensor 10.

S, T, U: The row 14a, 14b, 14c of light emitting diodes is dimmed in order to generate the desired mixed light, for example slow reduction in intensity down to complete brightness.

V: The flowchart is repeated at element A.

A further exemplary embodiment of lanterns 1 described here is explained in more detail in conjunction with FIG. 11. In this exemplary embodiment, a multiplicity of lanterns 1 such as are described in conjunction with FIG. 9 are connected to a central device 11 for controlling or for regulating the lantern. For example, the device 11 can take over the controlling of all lanterns 1 of a stretch of road. The lanterns 1 can in this case be controlled as a function of a sensor 10 that, for example, determines the air humidity and/or the ambient brightness, and also by inputs 20 that can be performed by persons and by means of which, for example, it is possible to adapt the lighting to events such as an accident on the street to be lit. For example, in the case of an accident, mixed light generated by the lanterns 1 can be increased to a maximum value by input from a user in order to light the accident site optimally. After clearing of the accident site, it is possible, in turn, to return by input from a user to the normal program run, as explained in conjunction with FIG. 10, for example.

The description with the aid of exemplary embodiments does not restrict invention to the latter. Rather, the invention comprises each new feature and each combination of features, this particularly including each combination of features in the patent claims, even if this feature or this combination is not itself specified explicitly in the patent claims or exemplary embodiments.

This patent application claims the priority of German patent application DE 102008054050.1, the disclosure content of which is hereby adopted by referring back.

1. A lantern, in particular a street lamp, comprising:
a lamp post; and
at least two light emitting diodes that are set up to emit, in operation, electromagnetic radiations with electromagnetic spectra differing from one another,
wherein the light emitting diodes are fastened in or on the lamp post.

2. The lantern according to claim 1, wherein the lantern has no lamp head.

3. The lantern according to claim 1, wherein the at least one light emitting diode is arranged on a top of the lamp post.

4. The lantern according to claim 1, wherein the lamp post has a top and wherein the lamp post tapers in the direction of its top.

5. The lantern according to claim 1, wherein a distance between two light emitting diodes in a direction of a main extent of the lamp post is at least 1/40th of the length of the lamp post.

6. The lantern according to claim 5, wherein at least one row of light emitting diodes is arranged along the direction of the main extent of the lamp post, each row comprising at least two light emitting diodes.

7. The lantern according to claim 1, wherein the lamp post has a bend.

8. The lantern according to claim 1, wherein the lamp post is designed at least partially as a reflector for the electromagnetic radiation generated in operation by the light emitting diodes.

9. The lantern according to claim 1, wherein a multiplicity of light emitting diodes is arranged as a ring, the ring enclosing the lamp post.

10. The lantern according to claim 1, comprising at least one sensor that is fastened on or in the lamp post, the sensor serving to determine at least one of the following measured variables: temperature, air humidity, ambient brightness, visibility conditions.

11. The lantern according to claim 10, comprising a device that is set up to control and/or to regulate the electromagnetic spectrum and the intensity of the mixed light emitted by the light emitting diodes.

12. The lantern according to claim 11, wherein the device is set up to control and/or to regulate the electromagnetic spectrum and the intensity of the mixed light emitted by the light emitting diodes as a function of at least one of the following measured variables: air humidity, temperature, ambient brightness, time of day, visibility conditions.

13. A method for converting a lantern, comprising the steps of:
removing a lamp head from a lamp post of a lantern; and
fastening at least two light emitting diodes to the lamp post, that are set up to emit, in operation, electromagnetic radiations with electromagnetic spectra differing from one another.

14. The method according to claim 13, wherein a distance between two light emitting diodes in a direction of a main extent of the lamp post is at least 1/40th of the length of the lamp post.

15. A method for operating a lantern according to claim 1, wherein at a prescribable time of day the color location of the mixed light emitted by the light emitting diodes of the lantern is changed from light with a low color rendering index to light with a high color rendering index.

16. A street lamp comprising:
a lamp post, and
at least two light emitting diodes that are set up to emit, in operation, electromagnetic radiations with electromagnetic spectra differing from one another,
wherein the light emitting diodes are fastened in the lamp post,
wherein a distance between two light emitting diodes in a direction of a main extent of the lamp post is at least 1/40th of the length of the lamp post, and
wherein the lamp post is designed at least partially as a reflector for the electromagnetic radiation generated in operation by the light emitting diodes.

17. The street lamp according to claim 16, comprising a device that comprises a microcontroller, wherein the device is configured to change the color location of the mixed light emitted by the light emitting diodes of the street lamp from light with a low color rendering index to light with a high color rendering index at a prescribable time of day.

18. The street lamp according to claim 17, comprising at least one sensor that is fastened on or in the lamp post, the sensor serving to determine at least one of the following measured variables: temperature, air humidity, ambient brightness, visibility conditions.

19. The street lamp according to claim 18, wherein the device is set up to control and/or to regulate the electromagnetic spectrum and the intensity of the mixed light emitted by the light emitting diodes as a function of at least one of the following measured variables: air humidity, temperature, ambient brightness, visibility conditions.

20. The street lamp according to claim 16, wherein:
the lamp post has a single recess,
all of the light emitting diodes are arranged in the single recess,
the light emitting diodes are covered with a cover plate,
the cover plate is transparent or milky, and
the cover plate terminates flush with a outer surface of the lamp post.
